(19) United States
(12) Patent Application Publication
(10) Pub. No.: US 2013/0201574 A1
(43) Pub. Date: Aug. 8, 2013

(54) PHOTOTHERAPY METHOD AND APPARATUS

(71) Applicant: Satish Kumar GOPALAKRISHNAN, Bangalore (IN)

(72) Inventor: Satish Kumar GOPALAKRISHNAN, Bangalore (IN)

(21) Appl. No.: 13/365,812

(22) Filed: Feb. 3, 2012

(51) Int. Cl. G02B 5/22

(52) U.S. Cl. 359/891

(57) ABSTRACT

A system for treating hyperbilirubinemia includes an optical apparatus adapted to separate a light into a plurality of constituent spectral colors. The system also includes a filter adapted to receive the constituent spectral colors from the optical apparatus. The filter is configured to transmit a predefined wavelength range of the constituent spectral colors and to block the remainder of the constituent spectral colors outside the predefined wavelength. The predefined wavelength range exclusively comprises wavelengths suited for the treatment of hyperbilirubinemia.

### BACKGROUND OF THE INVENTION

The subject matter disclosed herein relates to a phototherapy method and apparatus for the treatment of hyperbilirubinemia.

Hyperbilirubinemia is a medical condition in which the bilirubin level in the blood is too high. Bilirubin is a yellow break down product of hemoglobin. Hypervilirubinemia results in the yellow coloring of the skin and eyes, and can cause Jaundice if not treated. Hyperbilirubinemia is common in infants as their liver may initially be incapable of processing bilirubin.

Phototherapy devices are used to treat newborns with hyperbilirubinemia. Phototherapy devices commonly have an electrically powered light that is located above the infant and which radiates light in the wavelength range of approximately 420 to 480 nm to break down bilirubin into forms that can be eliminated from the body.

One problem with conventional phototherapy devices is that electrical power is needed to generate the light. Electrical power may not be available in all remote or rural hospitals.

### BRIEF DESCRIPTION OF THE INVENTION

The above-mentioned shortcomings, disadvantages and problems are addressed herein which will be understood by reading and understanding the following specification.

In an embodiment, a system for treating hyperbilirubinemia includes an optical apparatus adapted to separate a light into a plurality of constituent spectral colors. The system also includes a filter adapted to receive the constituent spectral colors from the optical apparatus. The filter is configured to transmit a predefined wavelength range of the constituent spectral colors and to block the remainder of the constituent spectral colors outside the predefined wavelength. The predefined wavelength range exclusively comprises wavelengths suited for the treatment of hyperbilirubinemia.

In another embodiment, a system for treating hyperbilirubinemia includes an optical apparatus adapted to separate a light into a plurality of constituent spectral colors. The system also includes a filter adapted to receive the constituent spectral colors from the optical apparatus. The filter is configured to transmit a predefined wavelength range of the constituent spectral colors and to block the remainder of the constituent spectral colors outside the predefined wavelength. The predefined wavelength range exclusively comprises wavelengths suited for the treatment of hyperbilirubinemia. The system also includes a light guide adapted to receive the predefined wavelength range from the filter and to direct the predefined wavelength range to a selectable location. The system also includes a dispersion apparatus adapted to receive the predefined wavelength range from the light guide, and to generally uniformly disperse the predefined wavelength range over a predefined area.

Various other features, objects, and advantages of the invention will be made apparent to those skilled in the art from the accompanying drawings and detailed description thereof.

### BRIEF DESCRIPTION OF THE DRAWINGS

FIG. 1 is an exploded sectional view of a phototherapy system in accordance with an embodiment; and

FIG. 2 is a sectional view of the phototherapy system in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

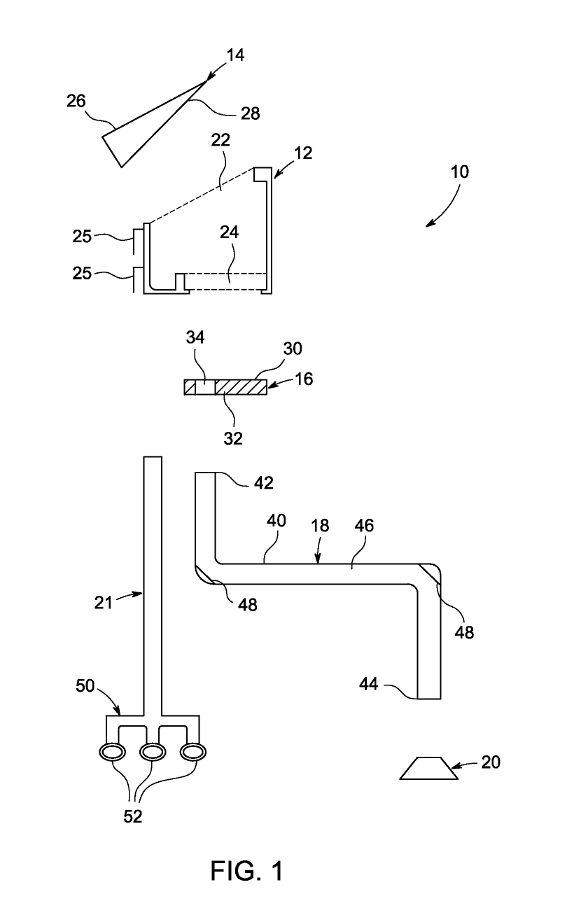

Referring to FIG. 1, an exploded sectional view of a phototherapy system 10 is depicted in accordance with an embodiment. The phototherapy system 10 may comprise a housing 12, an optical apparatus 14, a filter 16, a light guide 18, a dispersion apparatus 20, and a stand 21.

The housing 12 may define a first aperture 22 and a second aperture 24. The housing 12 may optionally comprise one or more mounting hooks 25. The optical apparatus 14 may be disposed within the first aperture 22 of the housing 12. The optical apparatus 14 will hereinafter be described in accordance with an embodiment as a prism 14, however an alternate optical apparatus such as a lens may be implemented. The prism 14 comprises a first surface 26 and a second surface 28.

The filter 16 may be disposed within the second aperture 24 of the housing 12. The filter 16 is aligned with and positioned in close proximity to the second surface 28 of the prism 14. The filter 16 may define a top surface 30 generally facing the prism 14. The filter 16 may comprise an opaque portion 32 that blocks the passage of all wavelengths of light, and a translucent or transparent portion 34 configured to transmit a predefined wavelength range of light.

The light guide 18 may comprise a cylindrical conduit 40 defining a first terminal end 42, a second terminal end 44 and a generally hollow interior 46. The first terminal end 42 of the conduit 40 may be connected to the housing 12 or directly to the filter 16. The light guide 18 is positioned such that the hollow interior 46 of the conduit 40 is aligned with the transparent portion 34 of the filter 16. The light guide 18 may comprise one or more reflectors 48 disposed within the hollow interior 46. According to an alternate embodiment, the light guide 18 may comprise an optical fiber.

The dispersion apparatus 20 will hereinafter be described in accordance with an embodiment as at least one dispersing lens 20, however an alternate dispersion apparatus such as an array of lenses or a pod that encapsulates the infant may be implemented. The dispersing lens 20 may be connected to the second terminal end 44 of the light guide conduit 40.

The stand 21 is an optional component that may be mounted directly to the housing 12. The stand 21 may comprise a base 50 having a plurality of wheels 52. Having described the components of the phototherapy system 10, their operation will now be explained in more detail.

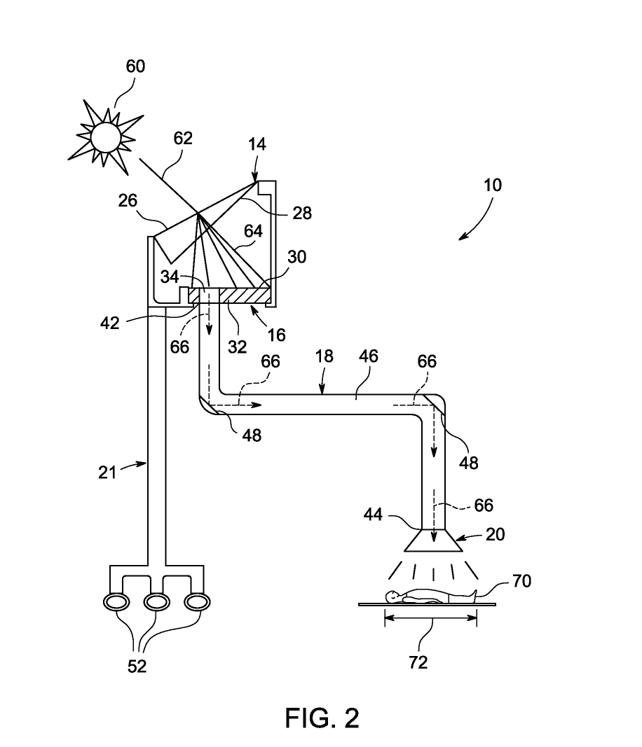

Referring to FIG. 2, the phototherapy system 10 is shown as assembled and in accordance with an embodiment. The prism 14 is arranged or positioned to be in communication with a source of light 60. The source of light 60 will hereinafter be described as the sun 60, however other natural and/or artificial light sources may be implemented. Implementing solar power to operate the phototherapy system 10 eliminates reliance on more traditional power sources such as electricity. This is particularly advantageous in developing countries in which traditional power sources may be unavailable or unreliable.

The phototherapy system 10 may be mounted via the mounting hooks 25 (shown in FIG. 1) to an exterior wall of a building or to an interior wall disposed in close proximity to a window in order to ensure the prism 14 remains in communication with the sun 60. Alternatively, the phototherapy system 10 may implement the optional stand 21 with wheels 52 to more conveniently transport the prism 14 into communication with the sun 60.

Light 62 from the sun 60 enters the prism 14 via the first surface 26, is broken up into its constituent spectral colors 64, and exits the prism 14 via the second surface 28. The operation of optical prisms to break up light into its constituent spectral colors is well known to those skilled in the art and will not be described in detail.

The filter 16 is positioned relative to the prism 14 such that the spectral colors 64 passing through the second surface 28 of the prism 14 are directed toward the top surface 30 of the filter 16. The filter 16 may be disposed in sufficiently close proximity to the prism 14 to ensure the spectral colors 64 are spread uniformly across the top surface 30 of filter 16. The transparent portion 34 of the filter 16 is positioned relative to the prism 14 such that a predefined wavelength range 66 of the spectral colors 64 is permitted to pass therethrough. The predefined wavelength range 66 comprises wavelengths suited for the treatment of hyperbilirubinemia. It has been observed that the wavelength range best suited for the treatment of hyperbilirubinemia is wavelength range 400 nm to 490 nm and most preferably the blue and green light in the 420 nm to 480 nm wavelength range.

As previously described, the spectral colors 64 passing through the second surface 28 of the prism 14 are spread uniformly across the top surface 30 of filter 16. The portion of the spectral colors 64 within the predefined wavelength range 66 is permitted to pass through the transparent portion 34 of the filter 16. The remainder of the spectral colors 64 outside the predefined wavelength 66 is blocked by the opaque portion 32 of the filter 16. By transmitting only the predefined wavelength range 66, the phototherapy system 10 can treat hyperbilirubinemia without exposing a patient to potentially harmful ultra violet light, dust and/or other pollutants that may be present in an open environment.

The light guide 18 is adapted to transmit the predefined wavelength range 66 from the filter 16 toward an infant 70. The light guide 16 is preferably flexible in order to accommodate a variety of different infant positions without having to move the prism 14. The predefined wavelength range 66 enters light guide 16 at the first terminal end 42 and is emitted out the second terminal end 44. One or more reflectors 48 disposed within the hollow interior 46 may be implemented to direct the predefined wavelength range 66 toward the infant 70.

The dispersing lens 20 is adapted to receive the predefined wavelength range 66 from the light guide 18, and to generally uniformly disperse the predefined wavelength range 66 over a predefined area 72. The predefined area 72 may be sized and positioned to precisely accommodate the infant 70 such that all of the infant's exposed skin receives a generally equal amount of the predefined wavelength range 66. This uniform application of the predefined wavelength range 66 over all the infant's exposed skin has been shown to optimally treat hyperbilirubinema.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

I claim:

1. A system for treating hyperbilirubinemia comprising:
an optical apparatus adapted to separate a light into a plurality of constituent spectral colors; and
a filter adapted to receive the constituent spectral colors from the optical apparatus, said filter configured to transmit a predefined wavelength range of the constituent spectral colors and to block the remainder of the constituent spectral colors outside the predefined wavelength, said predefined wavelength range exclusively comprising wavelengths suited for the treatment of hyperbilirubinemia.

2. The system of claim 1, wherein the optical apparatus comprises one of a prism, a lens, and a light-dispersing apparatus.

3. The system of claim 1, wherein the predefined wavelength range comprises wavelengths between 400 nm and 490 nm.

4. The system of claim 1, further comprising a light guide adapted to receive the predefined wavelength range from the filter and to direct the predefined wavelength range to a selectable location.

5. The system of claim 4, wherein the light guide is flexible in order to facilitate the process of directing the predefined wavelength to a selectable location.

6. The system of claim 4, further comprising a dispersion apparatus adapted to receive the predefined wavelength range from the light guide, and to generally uniformly disperse the predefined wavelength range over a predefined area.

7. The system of claim 6, wherein the predefined area is defined to accommodate an infant patient.

8. The system of claim 6, wherein the dispersion apparatus comprises one of a lens, an array of lenses, and a pod.

9. A system for treating hyperbilirubinemia comprising:
an optical apparatus adapted to separate a light into a plurality of constituent spectral colors;
a filter adapted to receive the constituent spectral colors from the optical apparatus, said filter configured to transmit a predefined wavelength range of the constituent spectral colors and to block the remainder of the constituent spectral colors outside the predefined wavelength, said predefined wavelength range exclusively comprising wavelengths suited for the treatment of hyperbilirubinemia;
a light guide adapted to receive the predefined wavelength range from the filter and to direct the predefined wavelength range to a selectable location; and
a dispersion apparatus adapted to receive the predefined wavelength range from the light guide, and to generally uniformly disperse the predefined wavelength range over a predefined area.

10. The system of claim 9, wherein the optical apparatus comprises a prism.

11. The system of claim 9, wherein the predefined wavelength range comprises wavelengths between 400 nm and 490 nm.

12. The system of claim 9, wherein the guide is flexible in order to facilitate the process of directing the predefined wavelength to a selectable location.

13. The system of claim 9, wherein the predefined area is defined to accommodate an infant patient.

14. The system of claim 9, wherein the dispersion apparatus comprises a lens.
